(19) United States
(12) Patent Application Publication
(10) Pub. No.: US 2024/0323809 A1
(43) Pub. Date: Sep. 26, 2024

(54) SYSTEM AND METHOD TO OPTIMIZE BLUETOOTH MESH NETWORKS

(71) Applicant: Silicon Laboratories Inc., Austin, TX (US)

(72) Inventors: Hasan Ali Stationwala, Hyderabad (IN); Ayan Bandhu Ghosh, Dumdum (IN)

(21) Appl. No.: 18/124,960

(22) Filed: Mar. 22, 2023

(51) Int. Cl. H04W 48/10; H04W 56/00

(52) U.S. Cl. CPC H04W 48/10; H04W 56/001; H04W 84/18

(57) ABSTRACT

A system and method to improve latency in a Bluetooth mesh network is disclosed. In many Bluetooth mesh networks, devices may not be available due to power saving mode or participation in other networks. This behavior slows the propagation of packets through the Bluetooth mesh network. To address this shortcoming, the method includes transmitting a periodic advertisement from a first, or originating, device. Contained within that periodic advertisement is schedule information associated with the transmission of mesh packets, which are typically transmitted at random times. The first device later transmits mesh packets in accordance with the schedule. This is referred to as a synchronized listening window configuration. Further, other devices in the mesh network also implement the synchronized listening configuration. In this way, packets are able to propagate through the mesh network more quickly.

### FIELD

This disclosure describes a system and method to optimize the latency in a Bluetooth Mesh Network.

### BACKGROUND

The mesh network defined by Bluetooth allows a very large number of network devices to be part of the same network. In the Bluetooth Mesh Network, packets flood the network. A first network device may transmit a packet. Each network device that receives the packet from the first network device then retransmits the packet. This process continues to allow the packet to propagate to all of the network devices in the network.

Several mechanisms may be used to limit the number of packets that are traversing the network. The first is that each network device may track which packets it has already retransmitted, such that it will not retransmit the same packet more than a predetermined number of times. Additionally, the packet may include a Time to Live (TTL) field, which indicates how long it may persist in the network. In some embodiments, this TTL field may be set to a value, which is decremented each time the packet is retransmitted. When the packet is received by another network device, it checks the TTL field. If this field has reached a lower limit, the packet is simply discarded and not retransmitted.

One feature of mesh networks is that messages are broadcast such that multiple devices receive the packet. Those devices that received the packet then forward it, such that the packet may be forwarded throughout the network. If all of the network devices are listening for the packet, the packet may travel quickly through the mesh network. However, if only a portion of the network devices within listening range of the original transmitter receive the packet, it may take longer for this packet to propagate throughout the mesh network.

This scenario may happen when network devices are a part of a different network, such that they are not always listening for packets in the Bluetooth Mesh network. This scenario may also happen when network devices enter a sleep mode for extended periods of time.

Therefore, it would be beneficial if there was a system and method that allowed the network devices in a mesh network to coordinate their availability with the transmission of new packets.

### SUMMARY

A system and method to improve latency in a Bluetooth mesh network is disclosed. In many Bluetooth mesh networks, devices may not be available due to power saving mode or participation in other networks. This behavior slows the propagation of packets through the Bluetooth mesh network. To address this shortcoming, the method includes transmitting a periodic advertisement from a first, or originating, device. Contained within that periodic advertisement is schedule information associated with the transmission of mesh packets, which are typically transmitted at random times. The first device later transmits mesh packets in accordance with the schedule. This is referred to as a synchronized listening window configuration. Further, other devices in the mesh network also implement the synchronized listening configuration. In this way, packets are able to propagate through the mesh network more quickly.

According to one embodiment, a method of communicating between a first device and a remote device in a Bluetooth mesh network is disclosed. The method comprises transmitting a periodic advertisement from the first device, wherein the periodic advertisement comprises information that provides a schedule regarding transmission of a mesh packet by the first device; and transmitting the mesh packet at a time defined by the schedule. In some embodiments, the information comprises a starting time, wherein the starting time is with respect to an anchor point of the periodic advertisement and defines a start of a mesh listening window. In some embodiments, the information comprises a listen duration, which defines a duration of the mesh listening window, during which time the remote device is requested to listen for the mesh packet. In some embodiments, the information comprises a window periodicity, which indicates a frequency of the mesh listening windows. In some embodiments, an advertisement interval is defined as a time between successive periodic advertisements, and multiple mesh listening windows are scheduled per advertisement interval. In some embodiments, an advertisement interval is defined as a time between successive periodic advertisements, and a mesh listening window is scheduled per multiple advertisement intervals. In some embodiments, an advertisement interval is defined as a time between successive periodic advertisements, and the schedule is associated with a plurality of periodic advertisements. In some embodiments, the information comprises an indication to the remote device that the first device will follow the schedule for all mesh packets. In some embodiments, a nearby device is disposed between the first device and the remote device, and the method further comprises receiving, at the nearby device, the periodic advertisement from the first device; determining that the first device is using synchronized listening window configuration; transmitting, by the nearby device, an additional periodic advertisement, after receiving the periodic advertisement from the first device, wherein the additional periodic advertisement comprises information that provides a schedule regarding transmission of a mesh packet by the nearby device; and retransmitting, by the nearby device, the mesh packet at a time defined by the schedule provided in the additional periodic advertisement.

According to another embodiment, a network device for use in a Bluetooth mesh network is disclosed. The network device comprises a Bluetooth network interface; a processing unit; and a memory device comprising instructions, which when executed by the processing unit, enable the network device to receive a periodic advertisement from a first device, wherein the periodic advertisement comprises information that provides a schedule regarding transmission of a mesh packet by the first device; and configure the Bluetooth network interface to be listening for the mesh packet during a mesh listening window defined by the schedule. In some embodiments, the schedule provides a starting time, which is a time after an anchor point of the periodic advertisement, and wherein the starting time defines a start of the mesh listening window. In certain embodiments, the schedule provides a listen duration, which defines a duration of the mesh listening window. In some embodiments, the schedule provides a window periodicity, which indicates a frequency of the mesh listening window. In certain embodiments, the memory device further comprises instructions, which when executed by the processing unit, enable the network device to configure the Bluetooth network interface to be listening during a second mesh listening window after receipt of a second periodic advertisement. In some embodiments, the memory device further comprises instructions, which when executed by the processing unit, enable the network device to receive a mesh packet from the first device; an transmit additional periodic advertisement, after receiving the periodic advertisement from the first device, wherein additional periodic advertisement the comprises information that provides a schedule regarding transmission of the mesh packet by the network device; and retransmit the mesh packet at a time defined by the schedule provided in the additional periodic advertisement.

According to another embodiment, a Bluetooth mesh network is disclosed. The Bluetooth mesh network comprises a first device; and a nearby device, comprising a network interface, within listening range of the first device; wherein the first device transmits a periodic advertisement containing schedule information regarding transmission of a mesh packet and transmits the mesh packet at a time indicated by the schedule information; and wherein the nearby device receives the periodic advertisement, configures the network interface to be awake at the time indicated by the schedule information in the periodic advertisement and receives the mesh packet. In some embodiments, the Bluetooth mesh network comprises a remote device, comprising a network interface, within listening range of the nearby device and outside listening range of the first device. In some embodiments, the nearby device transmits an additional periodic advertisement containing schedule information regarding transmission of the mesh packet by the nearby device; and transmits the mesh packet at a time indicated by the schedule information in the additional periodic advertisement. In certain embodiments, the remote device receives the additional periodic advertisement, configures the network interface to be awake at the time indicated by the schedule information in the additional periodic advertisement and receives the mesh packet.

### BRIEF DESCRIPTION OF THE DRAWINGS

For a better understanding of the present disclosure, reference is made to the accompanying drawings, in which like elements are referenced with like numerals, and in which:

FIG. 1A shows a block diagram of a Bluetooth device according to one embodiment;

FIG. 1B shows a Bluetooth mesh network including a first device and multiple remote devices;

FIG. 2 shows a flowchart that may be executed by the first device; and

FIG. 3 shows a flowchart that may be executed by another device in the Bluetooth mesh network.

### DETAILED DESCRIPTION

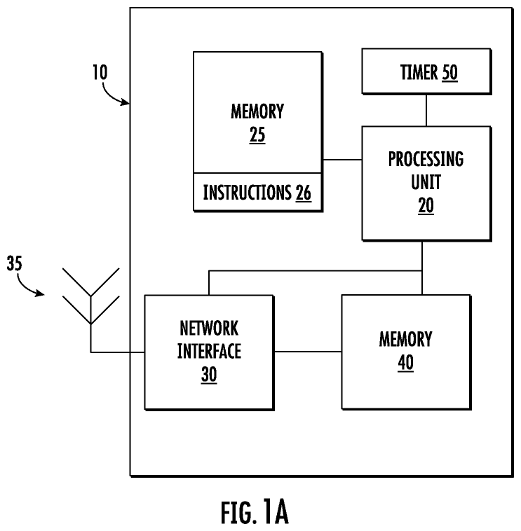

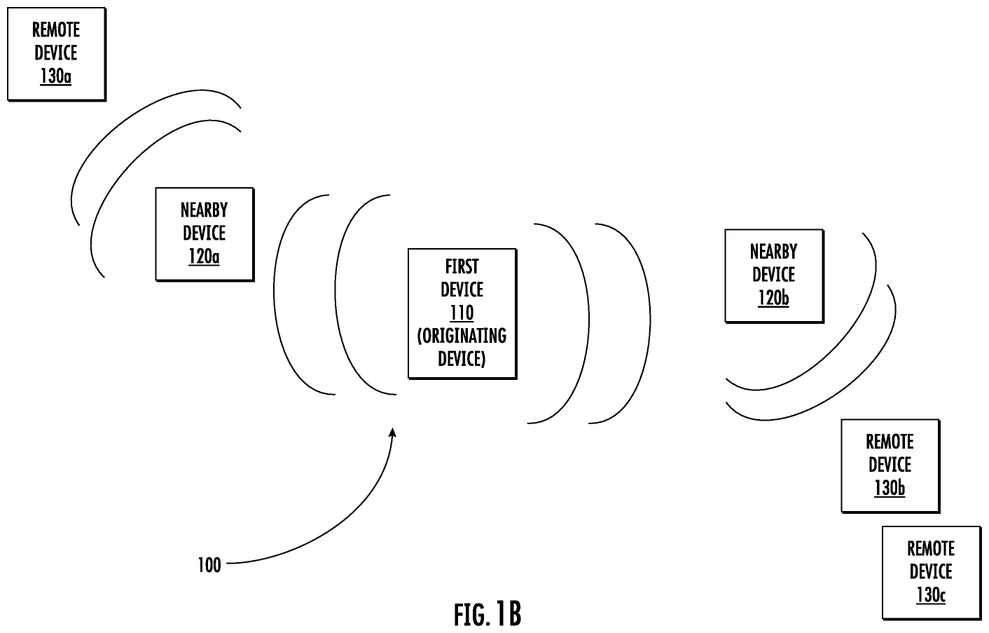

FIG. 1A shows a block diagram of a representative Bluetooth device 10 that may be used to implement the disclosed method of optimizing performance in a mesh network. The Bluetooth device 10 may be a device that transmits the first packet in the mesh network, or may be a device that receives a packet and retransmits it.

The Bluetooth device 10 has a processing unit 20 and an associated memory device 25. The processing unit 20 may be any suitable component, such as a microprocessor, embedded processor, an application specific circuit, a programmable circuit, a microcontroller, or another similar device. This memory device 25 contains the instructions 26, which, when executed by the processing unit 20, enable the Bluetooth device 10 to perform the functions described herein. This memory device 25 may be a non-volatile memory, such as a FLASH ROM, an electrically erasable ROM or other suitable devices. In other embodiments, the memory device 25 may be a volatile memory, such as a RAM or DRAM.

While a memory device 25 is disclosed, any computer readable medium may be employed to store these instructions. For example, read only memory (ROM), a random access memory (RAM), a magnetic storage device, such as a hard disk drive, or an optical storage device, such as a CD or DVD, may be employed. Furthermore, these instructions may be downloaded into the memory device 25, such as for example, over a network connection (not shown), via CD ROM, or by another mechanism. These instructions may be written in any programming language, which is not limited by this disclosure. Thus, in some embodiments, there may be multiple computer readable non-transitory media that contain the instructions described herein. The first computer readable non-transitory media may be in communication with the processing unit 20, as shown in FIG. 1A. The second computer readable non-transitory media may be a CDROM, or a different memory device, which is located remote from the Bluetooth device 10. The instructions contained on this second computer readable non-transitory media may be downloaded onto the memory device 25 to allow execution of the instructions by the Bluetooth device 10.

The Bluetooth device 10 also includes a Bluetooth network interface 30 that connects with a Bluetooth mesh network 100 using an antenna 35.

The Bluetooth device 10 may include a second memory device 40 in which data that is received and transmitted by the Bluetooth network interface 30 is stored. This second memory device 40 is traditionally a volatile memory. The processing unit 20 has the ability to read and write the second memory device 40 so as to communicate with the other devices in the Bluetooth mesh network 100.

Although not shown, the Bluetooth device 10 also has a power supply, which may be a battery or a connection to a permanent power source, such as a wall outlet.

While the processing unit 20, the memory device 25, the Bluetooth network interface 30 and the second memory device 40 are shown in FIG. 1A as separate components, it is understood that some or all of these components may be integrated into a single electronic component. Rather, FIG. 1A is used to illustrate the functionality of the Bluetooth device 10, not its physical configuration.

FIG. 1B shows a Bluetooth mesh network 100 that includes a plurality of network devices, all of which may have an architecture similar to that shown in FIG. 1A. However, the processing power, memory capability and power requirements of the first device 110 may be greater than that of the other devices.

In this figure, an originating device, also referred to as a first device 110, may be the first device to transmit a packet into the Bluetooth mesh network 100. Nearby devices 120a, 120b may receive the packet transmitted by the first device 110 and retransmit it to more distant nodes. A nearby device is defined as one within listening distance of the first device 110. This figure shows two nearby devices 120a, 120b, however, the number of nearby devices is not limited by this disclosure.

Remote devices 130a, 130b, 130c may receive the packet after it is retransmitted by the nearby devices 120a, 120b. In this figure, nearby devices 120a, 120b receive the packet from the first device 110. Remote device 130a receives the packet when it is retransmitted by nearby device 120a and remote devices 130b, 130c receive the packet when it is retransmitted by nearby device 120b. These remote devices are said to be two hops from the first device 110. Further, remote device 130a is within the listening distance of nearby device 120a, but outside the listening distance of the first device 110. Likewise, remote devices 130b, 130c are within the listening distance of nearby device 120b, but outside the listening distance of the first device 110. Of course, there may be any number of remote devices. Further, the mesh network may be much larger such that some remote devices may be more than 2 hops from the first device 110.

Note that if nearby device 120a is asleep or otherwise unavailable to receive the packet from first device 110, it must wait until either the first device 110 retransmits the packet, or it receives the packet transmitted by nearby device 120b (if it is within the listening distance of nearby device 120b). Further, remote device 130a cannot receive this packet until nearby device 120a retransmits it.

During normal operation, the first device 110 may transmit periodic advertisements. Periodic advertisements are transmitted at regular intervals on a predetermined channel. These regular intervals may be multiples of 1.25 milliseconds, between 7.5 milliseconds and 81.91875 seconds. In this way, other network devices are able to enter a low power state and can wake up at predetermined times in order to receive the next periodic advertisement.

Because these periodic advertisements occur at regular intervals, all of the devices in the Bluetooth mesh network 100 within the listening distance may be synchronized to these periodic advertisements. In other words, each device within the listening distance of the first device 110 may have an internal timer 50 that informs it when the first device 110 will transmit a periodic advertisement. Thus, these devices are not in sleep mode and are not participating in another network when the periodic advertisement is sent. Consequently, all or most of the devices are able to receive the periodic advertisement.

Further, each nearby device 120a, 120b may also transmit periodic advertisements. Again, these periodic advertisements occur at regular intervals, such that all of the remote devices in the Bluetooth mesh network 100 within the listening distance of these nearby devices may be synchronized to these periodic advertisements.

Additionally, the first device 110 may also transmit advertisements, which are different from periodic advertisements, to the devices in the Bluetooth mesh network 100. These advertisements may also be referred to as mesh packets. The mesh packets are propagated through the Bluetooth mesh network 100 due to the retransmission of the mesh packet by the other devices in the mesh network.

However, unlike the periodic advertisements, there are no timing requirements for the mesh packets. Thus, the nearby devices 120a, 120b may not be prepared to receive these mesh packets when they are first transmitted by the first device 110. This requires the first device 110 to retransmit the mesh packet and increases latency in the mesh network.

To address this issue, a novel mechanism is provided. This mechanism is implemented by the first device 110, and also may be implemented by any device which is responsible for the retransmission of a mesh packet.

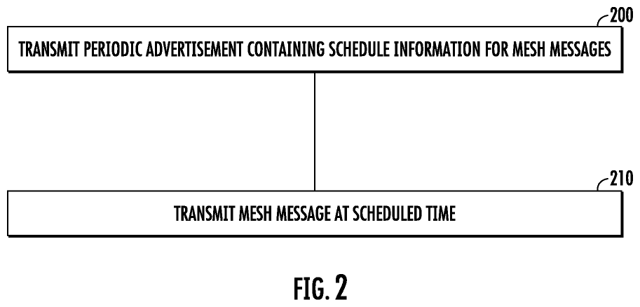

As shown in Box 200 of FIG. 2, the first device 110 may transmit a periodic advertisement. However, unlike traditional systems, this periodic advertisement contains information about when mesh packets may be transmitted. This information serves as a schedule, which informs the devices when the first device 110 may transmit a mesh packet. In some embodiments, the schedule is associated with only the current periodic advertisement. In other embodiments, the schedule is associated with the current periodic advertisement as well as subsequent periodic advertisements. In other words, the schedule may define the operation of the first device 110 during a plurality of advertisement intervals, where an advertisement interval is defined as the time between two successive periodic advertisements.

A vendor unique command may be used to identify that this information is being provided. This information may include a listen duration, which is defined as the duration of time during which other devices should be prepared to receive a mesh packet from the first device 110. This duration is used to define the mesh listening window. The information may also include a starting time, which may be relative to the periodic advertisement anchor point. This parameter informs the other devices how long after the current periodic advertisement anchor point the mesh listening window begins. In other words, the parameter may indicate that the mesh listening window begins 1.200 milliseconds after the current periodic advertisement anchor point. Thus, now, all of the devices within the listening distance of the first device 110 are aware of the fact that the first device 110 may transmit a mesh packet and when that transmission will occur.

Further, the information in the periodic advertisement may also include the window periodicity. This is defined as the frequency of the mesh listening windows. For example, the first device 110 may indicate that it may be transmitting a mesh packet after every second or third periodic advertisement. Thus, in this embodiment, a window periodicity of “1” may indicate that the first device 110 intends to transmit a mesh packet after every periodic advertisement. A window periodicity of “4” may indicate that the first device 110 intends to transmit a mesh packet after every fourth periodic advertisement.

In another embodiment, multiple mesh listening windows may be created between successive periodic advertisements. For example, the advertisement interval, which is the time between the consecutive periodic advertisements, may be set to a large number. Thus, the first device 110 may want the devices to listen for mesh packets multiple times during this advertisement interval. In this case, a window periodicity of “4” may indicate that there are four mesh listening windows during each advertisement interval. In certain embodiments, in addition to the listen duration and the starting time, the periodic advertisement may also include an additional parameter that defines the interval between successive mesh packets within an advertisement interval. In this way, the start time of each of the potential mesh packets may be determined by the remote devices.

In some embodiments, the field used for the window periodicity is configured so as to allow multiple mesh listening windows per advertisement interval and also allow a single mesh listening window per multiple advertisement intervals.

Finally, the first device 110 may indicate that it is operating in a synchronized listening window configuration. This indicates that, from this point forward, any mesh packets that are transmitted will be transmitted in accordance with the schedule provided in the periodic advertisement.

Thus, by using one or more vendor unique commands, the first device 110 may inform other devices when it intends to transmit mesh packets. In other words, the parameters used by the first device 110 in the periodic advertisement provide a schedule to the other devices, allowing them to synchronize their activities so as to receive the mesh packets when they are first transmitted.

While the above description uses parameters, such as a mesh listening window, a starting time and a window periodicity to define the schedule, it is understood that the other parameters may be used to provide the schedule.

For example, the starting time may refer to the next periodic advertisement anchor point. Alternatively, in some embodiments, the starting time may be represented as a percentage of the total time duration between anchor points.

Additionally, the window periodicity may be communicated in other ways. For example, the first device 110 may provide information in every periodic advertisement, informing the other devices of whether there will be a mesh packet following this periodic advertisement. However, this approach requires that the nearby devices 120a, 120b listen to every periodic advertisement.

In each of these embodiments, the first device 110 provides information in the periodic advertisement that provides a schedule to the other devices regarding when and how frequently mesh packets may be transmitted.

Later, as shown in Box 210, the first device 110 transmits a mesh packet at the time defined by the schedule provided in the periodic advertisement.

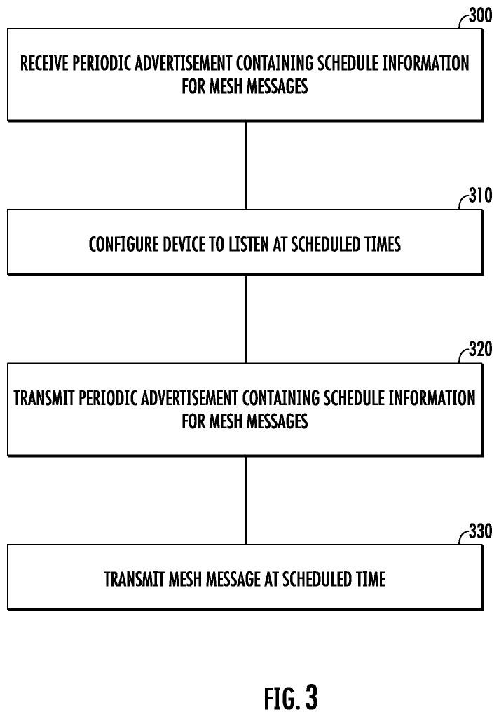

FIG. 3 shows the operation of another device, such as nearby device 120a. As shown in Box 300, nearby device 120a, receives this periodic advertisement from the first device 110. Using the schedule information provided in the periodic advertisement, the nearby device 120a may determine the intervals during which it should be listening for mesh packets from the first device 110, as shown in Box 310. Thus, the nearby device 120a may ensure that it is not asleep or participating is a different network during the predefined mesh listening windows.

Additionally, as shown in Box 320, the nearby device 120a may transmit its own periodic advertisement. The periodic advertisement sent by the nearby device 120a may also include schedule information, similar to that provided by the first device 110. However, the schedule information may be configured such that the mesh packets that were sent from the first device 110 have already been received and will be ready to be retransmitted by the nearby device 120a. In this way, the mesh packet transmitted by the first device 110 propagates through the mesh network quickly. Additionally, the nearby device 120a may indicate that it is also operating in a synchronized listening window configuration. This indicates that, from this point forward, the mesh packets will be transmitted in accordance with the schedule provided in the periodic advertisement.

Finally, as shown in Box 330, the nearby device 120a, transmits the mesh packet that it received from the first device 110 at the time indicated in the periodic advertisement.

Note that if the mesh network comprises a large number of hops, the sequence shown in FIG. 3 may be repeated by many devices.

The present system and method have many advantages. A simulation using 64 nodes configured in a daisy chain configuration was performed, wherein Device 2 can listen to Device 1 and transmit to Device 3; Device 3 can listen to Device 2 and transmit to Device 4; and so on. Note that, in this simulation, the listening range of all of the 64 nodes is only one hop. In this simulation, it is assumed that each node is listening 50% of the time, although that time is not synchronized across the mesh network. Next, a mesh packet was transmitted by Device 0. The time for the mesh packet to propagate through the entire mesh network was then measured. A second test was then performed, wherein the sequences shown in FIGS. 2 and 3 were performed so that all of the nodes were synchronized so as to be listening at the appropriate time to receive the mesh packet. Again, the time for the mesh packet to propagate through the entire mesh network was measured. It was found that this time was less than 50% of the time required by a conventional mesh network.

Another simulation was also performed, where the listening range of all devices was increased to two hops. In other words, Device 4 can listen to Device 3 as well as Device 2. Because of this, there is more redundancy in the mesh network and packets propagate more quickly. The time for the mesh packet to propagate through the entire mesh network was again measured. Next, as described above, the sequences shown in FIGS. 2 and 3 were performed so that all of the nodes were synchronized so as to be listening at the appropriate time to receive the mesh packet. Again, the time for the mesh packet to propagate through the entire mesh network was measured. In this case, all of the devices in the mesh network received the mesh packet in less than one third the time, representing an improvement of more than 300%.

Thus, this system and method allows for much lower latency through a mesh network by providing a schedule to all of the nodes as to when mesh packets are expected to be transmitted.

The present disclosure is not to be limited in scope by the specific embodiments described herein. Indeed, other various embodiments of and modifications to the present disclosure, in addition to those described herein, will be apparent to those of ordinary skill in the art from the foregoing description and accompanying drawings. Thus, such other embodiments and modifications are intended to fall within the scope of the present disclosure. Further, although the present disclosure has been described herein in the context of a particular implementation in a particular environment for a particular purpose, those of ordinary skill in the art will recognize that its usefulness is not limited thereto and that the present disclosure may be beneficially implemented in any number of environments for any number of purposes. Accordingly, the claims set forth below should be construed in view of the full breadth and spirit of the present disclosure as described herein.

What is claimed is:

1. A method of communicating between a first device and a remote device in a Bluetooth mesh network, the method comprising:
transmitting a periodic advertisement from the first device, wherein the periodic advertisement comprises information that provides a schedule regarding transmission of a mesh packet by the first device; and
transmitting the mesh packet at a time defined by the schedule.

2. The method of claim 1, wherein the information comprises a starting time, wherein the starting time is with respect to an anchor point of the periodic advertisement and defines a start of a mesh listening window.

3. The method of claim 2, wherein the information comprises a listen duration, which defines a duration of the mesh listening window, during which time the remote device is requested to listen for the mesh packet.

4. The method of claim 3, wherein the information comprises a window periodicity, which indicates a frequency of the mesh listening windows.

5. The method of claim 4, wherein an advertisement interval is defined a as time between successive periodic advertisements, and wherein multiple mesh listening windows are scheduled per advertisement interval.

6. The method of claim 4, wherein an advertisement interval is defined as a time between successive periodic advertisements, and wherein a mesh listening window is scheduled per multiple advertisement intervals.

7. The method of claim 1, wherein an advertisement interval is defined as a time between successive periodic advertisements, and the schedule is associated with a plurality of periodic advertisements.

8. The method of claim 1, wherein the information comprises an indication to the remote device that the first device will follow the schedule for all mesh packets.

9. The method of claim 1, further comprising a nearby device disposed between the first device and the remote device, wherein the method further comprises:
receiving, at the nearby device, the periodic advertisement from the first device;
determining that the first device is using synchronized listening window configuration;
transmitting, by the nearby device, an additional periodic advertisement, after receiving the periodic advertisement from the first device, wherein the additional periodic advertisement comprises information that provides a schedule regarding transmission of a mesh packet by the nearby device; and
retransmitting, by the nearby device, the mesh packet at a time defined by the schedule provided in the additional periodic advertisement.

10. A network device for use in a Bluetooth mesh network, comprising:
a Bluetooth network interface;
a processing unit; and
a memory device comprising instructions, which when executed by the processing unit, enable the network device to:
receive a periodic advertisement from a first device, wherein the periodic advertisement comprises information that provides a schedule regarding transmission of a mesh packet by the first device; and
configure the Bluetooth network interface to be listening for the mesh packet during a mesh listening window defined by the schedule.

11. The network device of claim 10, wherein the schedule provides a starting time, which is a time after an anchor point of the periodic advertisement, and wherein the starting time defines a start of the mesh listening window.

12. The network device of claim 11, wherein the schedule provides a listen duration, which defines a duration of the mesh listening window.

13. The network device of claim 12, wherein the schedule provides a window periodicity, which indicates a frequency of the mesh listening window.

14. The network device of claim 13, wherein the memory device further comprises instructions, which when executed by the processing unit, enable the network device to configure Bluetooth network interface to be listening during a second mesh listening window after receipt of a second periodic advertisement.

15. The network device of claim 10, wherein the memory device further comprises instructions, which when executed by the processing unit, enable the network device to:
receive a mesh packet from the first device;
transmit an additional periodic advertisement, after receiving the periodic advertisement from the first device, wherein the additional periodic advertisement comprises information that provides a schedule regarding transmission of the mesh packet by the network device; and
retransmit the mesh packet at a time defined by the schedule provided in the additional periodic advertisement.

16. A Bluetooth mesh network, comprising:
a first device; and
a nearby device, comprising a network interface,
within listening range of the first device;
wherein the first device transmits a periodic advertisement containing schedule information regarding transmission of a mesh packet and transmits the mesh packet at a time indicated by the schedule information; and
wherein the nearby device receives the periodic advertisement, configures the network interface to be awake at the time indicated by the schedule information in the periodic advertisement and receives the mesh packet.

17. The Bluetooth mesh network of claim 16, further comprising a remote device, comprising a network interface, within listening range of the nearby device and outside listening range of the first device.

18. The Bluetooth mesh network of claim 17, wherein the nearby device transmits an additional periodic advertisement containing schedule information regarding transmission of the mesh packet by the nearby device; and transmits the mesh packet at a time indicated by the schedule information in the additional periodic advertisement.

19. The Bluetooth mesh network of claim 18, wherein the remote device receives the additional periodic advertisement, configures the network interface to be awake at the time indicated by the schedule information in the additional periodic advertisement and receives the mesh packet.
